(19) United States
(12) Patent Application Publication
(10) Pub. No.: US 2010/0188636 A1
(43) Pub. Date: Jul. 29, 2010

(54) MULTIFOCAL OPHTHALMIC LENS HAVING REDUCED GHOSTING

(76) Inventors: Candido D. Pinto, Penfield, NY (US); David C. Compertore, Penfield, NY (US)

Correspondence Address: Bausch & Lomb Incorporated, One Bausch & Lomb Place, Rochester, NY, 14604-2701, US

(21) Appl. No.: 12/509,789

(22) Filed: Jul. 27, 2009

Related U.S. Application Data
(60) Provisional application No. 61/084,655, filed on Jul. 30, 2008.

(51) Int. Cl. G02C 7/06; G02C 7/04

(52) U.S. Cl. 351/161; 351/168; 351/171; 351/177

(57) ABSTRACT

An ophthalmic lens, comprising at least one optic including a first zone and a second zone having a second zone. The lens configured such that, when the lens is applied to an average eye, for objects located between infinity and a near focal plane of the average eye, an MTF of the eye's optical system has no phase reversals.

### CROSS REFERENCE

This application claims the benefit of Provisional Patent Application No. 61/084,655, filed Jul. 30, 2008, which is incorporated by reference herein.

### FIELD OF INVENTION

The present invention relates to ophthalmic lenses, and more particularly to multifocal ophthalmic lenses.

### BACKGROUND OF THE INVENTION

IOLs are ophthalmic lenses used to replace natural crystalline lenses of patients' when their natural lenses are diseased or otherwise impaired. Under some circumstances a natural lens may remain in a patient's eye together with an implanted IOL. IOLs may be placed in either the posterior chamber or the anterior chamber of an eye. A disadvantage of some conventional IOLs is that are have a single, fixed focal length. Such lenses provide a user with limited depth of field, and as such a wearer needs reading glasses to view near objects.

To overcome some of the disadvantages of single focus, monofocal, IOLs, IOLs have been produced that have two or more fixed focus zones each having a different focal length. For example, bifocal ophthalmic lenses have a first zone having a first, short focal length and a second zone having a second longer, focal length.

A common complaint of wearers of such lenses is that so called “ghost images” are produced. Ghost images arise when a first image is produced by one zone and another image is produced by another zone and the brain is unable to adequately ignore one of the images. Ophthalmic lenses other than IOLs (e.g., contact lenses, corneal onlays or inlays and eyeglasses) are also known to produce ghost image problems.

The degree to which the detrimental effects of ghosting are perceived by a wearer is determined in part by the type of lens that is worn. In the case of eyeglasses, the problem of ghost images can be mitigated if a wearer appropriately tilts his/her head or if the wearer appropriately positions the glasses. While the need to so tilt the head or position glasses is an inconvenience, other types of lenses (e.g., IOLs) offer no such option to mitigate ghosting.

### SUMMARY

The Applicants have determined that complaints by wearers of mulitzonal lenses that relate to ghosting arise at least in part due to phase-related disturbances occurring in an output wavefront of such lenses. The Applicants believe that, in such lenses, a portion of the wavefront emerging from the first zone and a portion of the wavefront emerging from a second zone form a wavefront with phase disturbances. In at least some prior art lenses, zones are designed independently of one another before they are formed on an ophthalmic lens, resulting in detrimental phase-related disturbances in an output wavefront from the lens.

Such phase-related disturbances are distinct from the mere formation of two images, one by each of the zones, in which one of the images is merely blurred (i.e., out of focus). Blurring errors and corresponding magnification errors are relatively easily ignored by the human brain, especially when the focal points are relatively far apart (e.g., as in a bifocal lens having one zone for reading and another zone for distance vision). By contrast, phase disturbances in a wavefront are difficult for the human brain to process and result in confused interpretations of images on the retina.

For illustrative purposes, an example of a phase disturbance and the resulting processing issues can be generated by adjusting one's spectacles such that an object is observed partially through the spectacle lens and partially around the lens. Such an arrangement results in a wearer seeing two images that appear to be transversely displaced from one another.

According to aspects of the present invention, portions of the first zone that are proximate the second zone and portions of the second zone that are proximate the first zone are selected to smooth the wavefront that is output of the lens. In particular, in some embodiments, the lens is configured such that, when the lens is applied to an eye, the second derivatives of the wavefront produced at the exit pupil of the eye's optical system are substantially zero 1) for an object at a focus of a first zone having a first focal length; 2) for an object at a focus of a second zone having a second focal length; and 3) for an object at a location intermediate the focus of the first zone and the focus of the second zone. Typically the lenses are designed to produce such wavefronts when applied to an average eye.

A characteristic of embodiments of lenses resulting from such lens configurations is that the modulation transfer functions (MTFs) of the eye optical system at the retina of the eye is non-zero for: 1) an object location corresponding to the focus of the first zone; 2) an object location corresponding to the focus of the second zone; and 3) an object location corresponding to the location intermediate the focus of the first zone and the focus of the second zone for visually significant spatial frequencies. It will be appreciated that spatial frequencies above a certain frequency (like other optical parameters outside corresponding ranges) are not perceived by human beings and are therefore insignificant.

Aspects of the present invention are directed to an ophthalmic lens, comprising at least one optic including a first zone and a second zone having a second zone, the lens being configured such that, when the lens is applied to an average eye, for objects located between infinity and a near focal plane of the average eye, an MTF of the eye's optical system has no phase reversals.

In some embodiments, the lens is an intraocular lens. In some embodiments, the lens comprises an anterior surface and a posterior surface, and each of the anterior surface and the posterior surface has at least two zones. The zones may be concentric.

In some embodiments, the lens has no phase reversal for objects having a spatial frequency in a range 0-50 lp/mm. In some embodiments, the lens has no phase reversal for objects having a spatial frequency in a range 0-75 lp/mm; and in some embodiments, the lens has no phase reversal for objects having a spatial frequency in a range 0-100 lp/mm.

In some embodiments, the near focal plane is located 1 meter or closer to the front of the eye. In such embodiments, a far focal plane of the lens may be adapted to provide the average eye with vision at an infinite distance from the eye.

In some embodiments, the near focal plane is located 65 centimeters or closer to the front of the eye. In such embodiments, a far focal plane of the lens may be adapted to provide the average eye with vision at an infinite distance from the eye.

In some embodiments, the lens comprises a third zone. In such embodiments, each of the three zones may have a different focal length. The MTF may have no phase reversals in a range between a focus of the first zone and a focus of the second zone. The MTF may have one or more phase reversals between a focus of the third zone and the range.

The lens may consist of a single element lens or may have additional optical elements.

Another aspect of the invention is directed to a method of designing a multizonal lens using a model eye including the lens, comprising optimizing the lens such that second derivatives of a wavefront at an exit pupil of the model eye optical system are substantially zero.

In some embodiments of the method, the lens comprises a first zone having a first focal length and a second zone having a second wavelength. In some embodiments, when the lens is applied to an average eye, the first focal length provides a first focal plane located 1 meter or closer to the front of an the eye and the second focal length provides a second focal plane at infinity.

In some embodiments, the step of optimizing comprises using even aspheric terms of at least one of an anterior surface and a posterior surface of the lens as variables.

In some embodiments, the method further comprises a step of designing a first zone for vision at a near focal plane, and a step of designing a second zone for vision at a far focal plane, both step being performed prior to the step of optimizing the lens.

The term “ophthalmic lens” as used herein includes but is not limited to eyeglasses, intraocular lenses, corneal inlays, corneal onlays and contact lenses.

A prescription defining an “average eye” as the term is used herein, and which is to be used to determine performance of lenses as described herein, is provided in Table 1. It will be recognized that the prescription is an eye model according to the Liou-Brennan eye model of 1997. Parameters, such as the index of refraction of the various media of the model, which are not specified herein have values as specified in the above identified eye model.

TABLE 1

| Name of | Radius of | | Thickness | |
|---|---|---|---|---|
| Surface | Curv.(mm) | Conic | (mm) | Medium |
| Anterior | 7.770000 | −0.180000 | 0.500000 | Cornea |
| Cornea | | | | |
| Posterior | 6.400000 | −0.600000 | 3.160000 | Aqueous Humor |
| Cornea | | | | |
| Pupil | Infinity | 0.000000 | 0.000000 | Aqueous Humor |
| Anterior | 12.400000 | −0.940000 | 1.590000 | Anterior |
| Lens | | | | Crystalline |
| Intermediate | Infinity | 0.000000 | 2.430000 | Posterior |
| Lens | | | | Crystalline |
| Posterior | −8.100000 | 0.960000 | 16.238830 | Vitreous Humor |
| Lens | | | | |
| Retina | −13.400000 | 0.000000 | — | — |

Furthermore, as one of ordinary skill in the art would understand, to develop a lens of a particular dioptric power (or to determine the performance of a lens of a particular dioptric power) the model eye can be adjusted in a software representation of the model such that a best-focus image is obtained on the retina of the model eye. Although multiple, substantially equivalent techniques may be used, for purposes of aspects of this invention, the position of the retina can be adjusted (i.e., by changing the distance between the posterior lens surface and the retina) to achieve best focus on the retina.

It will be appreciated that design and/or performance determinations of contact lenses can be achieved with the lens applied to an eye so as to have zero separation from the corneal surface of the eye model. It will also be appreciated that design and/or performance determinations of an intraocular lens (IOL) to be placed in the posterior capsule bag of the lens can be attained with the IOL being applied so as to be disposed midway (i.e., halfway) between the anterior and posterior crystalline lens surfaces, and with the optical power of said anterior and posterior surfaces removed. It will be appreciated that lenses located at various positions in the capsular bag will have substantially the same optical performance; such position independence is typically desirable since precise placement during surgery is difficult.

The above lens locations (i.e., on the cornea or in the capsular bag) are described by way of example. Any other lens can be applied at any suitable location in the eye model as determined by the lenses construction. The diameter of the iris in the average eye is not specified by the average eye, but may be separately specified.

The presence of two zones in a lens can be recognized by a presence of two local maxima in a plot of optical response as a function of vergence. An example of an optical response plot of a two-zone lens in an eye is shown in FIG. 6, where modulation (for a given spatial frequency) as a function of vergence (in diopters) is illustrated. Two local maxima 2a and 2b are shown, one corresponding to vision at an infinite distance and another corresponding to near distance. To plot modulation as a function of vergence, a modulation of visual significance is selected (e.g., modulation amplitude for a spatial 100 lp/mm). Although a plot of modulation is illustrated, examples of other suitable optical response parameters are contrast, strehl ration or resolution. The wavelength of the light used may be any visually significant bandwidth or wavelength of light such as the photopic spectrum. It will be appreciated that lenses according to aspects of the present invention can comprise three or more zones. The peaks are typically separated by at least 0.5 diopters; and in some embodiments the separation is at least 1.0 diopters. The locations of the peaks can be used to calculate focal lengths of the various zones.

### BRIEF DESCRIPTION OF THE DRAWINGS

Illustrative, non-limiting embodiments of the present invention will be described by way of example with reference to the accompanying drawings, in which the same reference number is used to designate the same or similar components in different figures, and in which:

FIG. 1A is a schematic plan view of an example of an ophthalmic lens according to aspects of the present invention;

FIG. 1B is a schematic cross-sectional view of the lens of FIG. 1A;

FIG. 1C is a flow chart illustrating an example of steps of a design technique according to aspects of the present invention;

FIGS. 2A-2B are MTF plots at a retina (located at best focus for each plot) for an optical system of an average eye with an example embodiment of an ophthalmic lens according to aspects of the present invention disposed therein, the plots corresponding to an object located an infinite distance from the eye, and an object at a 1.0 diopter distance, respectively;

FIGS. 3A-3C are MTF plots at a retina (located at best focus) for an optical system of an average eye with an example embodiment of an ophthalmic lens according to aspects of the present invention disposed therein, the plots corresponding to an object located an infinite distance from the eye, an object at a 1.0 diopter distance, and an object at a 1.5 diopter distance, respectively;

FIGS. 4A-4C are MTF plots at a retina (located at best focus) for an optical system of an average eye with an example embodiment of an ophthalmic lens according to aspects of the present invention disposed therein, the plots corresponding to an object located an infinite distance from the eye, an object at a 1.0 diopter distance, and an object at a 1.5 diopter distance, respectively;

FIGS. 5A-5C are MTF plots at a retina (located at best focus) for an optical system of an average eye with an example of a prior art lens disposed therein, the plots corresponding to an object located an infinite distance from the eye, an object at a 1.0 diopter distance, and an object at a 1.5 diopter distance, respectively; and

FIG. 6 illustrates an example of an optical response plot of a two-zone lens in an eye.

### DETAILED DESCRIPTION

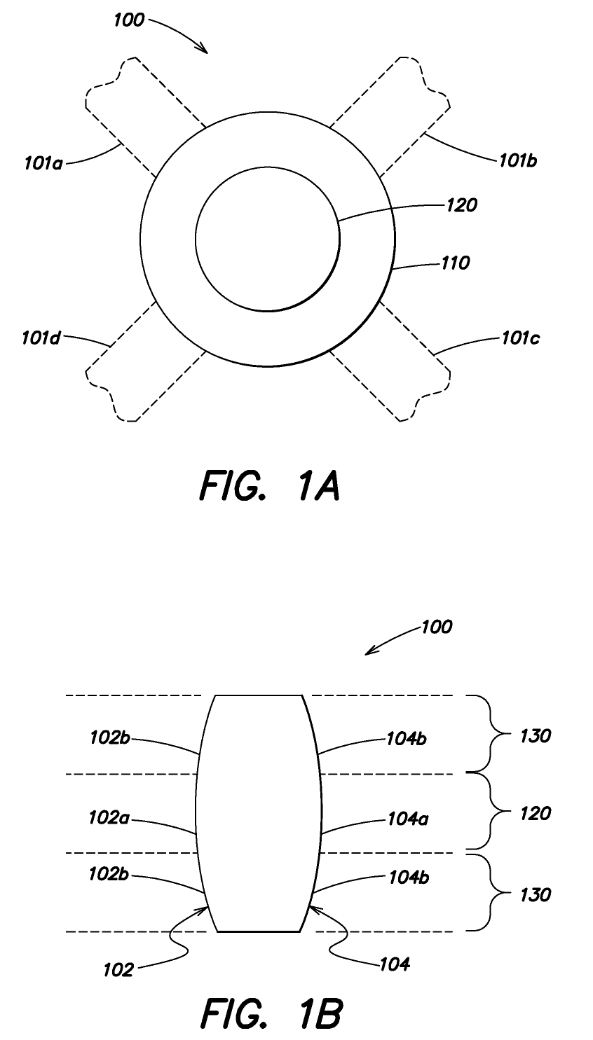

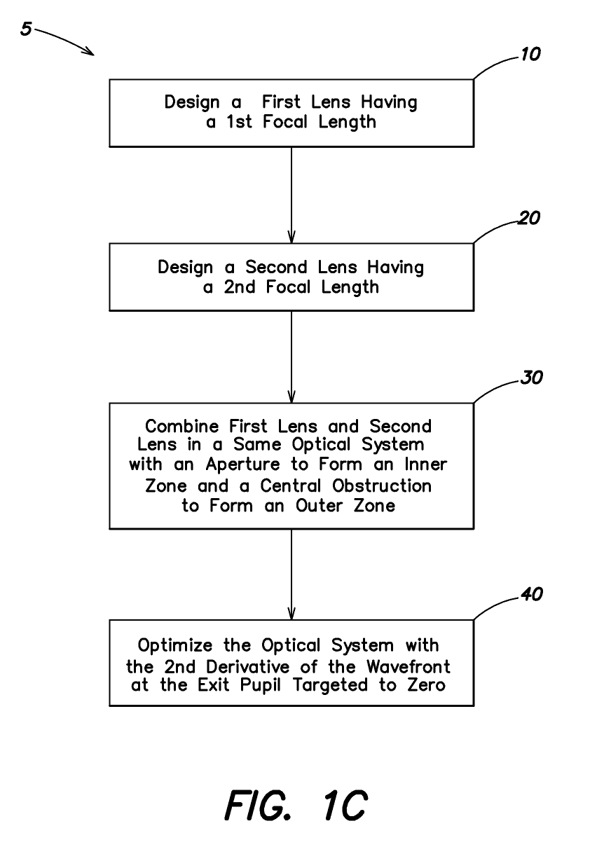

FIG. 1A is a schematic plan view of an example of an ophthalmic lens 100 according to aspects of the present invention. The lens comprises at least one optic 110. A lens according to aspects of the present invention may have any suitable fixation features configured to maintain the lens in a particular location in an eye. For example, an intraocular, ophthalmic lens may have one or two or more haptics (101a-101d). The haptics (shown in dashed lines) may have any suitable configuration.

FIG. 1B is a cross sectional view of the ophthalmic lens of FIG. 1A. As illustrated, optic 110 has an anterior surface 102 and a posterior surface 104. Lenses according to aspects of the present invention can comprise combinations of surfaces having any suitable shape (piano, convex, concave).

The optic includes a first zone 120 having a first focal length and a second zone 130 having a second focal length that is shorter than the first focal length. In the illustrated embodiment, both, the anterior surface has two zones 102a, 102b and the posterior surface has two zones 104a, 104b. In some embodiments of multizonal lenses, the optic may be configured such that only one of the anterior surface and the posterior surface has two zones. Also, although the illustrated embodiment has concentric circular zones, in other embodiments, the lenses may have two zones that are other than concentric (e.g., side by side).

Lens 100 is configured such that, when the lens is applied to an average eye, for objects located between infinity and a near focal plane of the average eye, the MTF of the eye optical system has no phase reversals. Alternatively stated, for object locations corresponding to: 1) a focus of the first zone (e.g., located at infinity), 2) a focus of the second zone, and 3) a location intermediate the focus of the first zone and the focus of the second zone, and all locations in between said locations, the MTF is non-zero. It will be appreciated that a zero-crossing in a plot of modulation (i.e., in an MTF plot) corresponds to a phase reversal. It will also be appreciated that the second focal length will determine the near focal plane.

To achieve such a configuration, an optimization may be performed in which, among other optimization parameters, the second derivatives are targeted to be zero at the exit pupil of the eye's optical system over a selected depth of field of the average eye extending between the focus of the first zone and the focus of the second zone. For example, an optical system of a healthy eye (e.g., as represented by the Liou-Brennan eye model of 1997) may include a cornea, the subject ophthalmic lens, various fluids of the eye, and possibly a natural crystalline lens, modified to include a given ophthalmic lens (e.g., the crystalline lens may be removed if the lens is to be placed in the capsular bag of the eye).

For example, the optimization may be performed such that the second derivative is targeted to be zero for object locations corresponding to: 1) a focus of the first zone; 2) a focus of the second zone; and 3) a location intermediate the focus of the first zone and the focus of the second zone. An example of a suitable optimization list (also commonly referred to as a “merit function”) includes terms as follows.

$$\frac{{\partial }^{2} x}{\partial {x}^{2}} = 0$$

$$\frac{{\partial }^{2} y}{\partial {y}^{2}} = 0$$

$$\frac{\partial x \partial y}{\partial {x}^{2}} = 0$$

$$\frac{\partial x \partial y}{\partial {y}^{2}} = 0$$

It will be appreciated that, although second derivatives equal to zero are targeted, the resulting second derivatives may only be substantially zero. In such instances, derivatives will only be substantially zero because a computer optimization is performed in which, among other parameters, said second derivatives are targeted to be zero. As a result, the actual derivatives may be relatively small finite numbers.

For example, in a lens having two zones, the optimization is performed such that the second derivative is substantially zero at the exit pupil of the eye optical system for object locations corresponding to: 1) a focus of the first zone; 2) a focus of the second zone; and 3) a location intermediate the focus of the first zone and the focus of the second zone. It will be appreciated that by selecting a target for wavefront performance at the exit pupil, the output of the optimization results in a suitable selection of parameters of both the anterior surface and the posterior surface of the ophthalmic lens, including parameters of a first optical zone and a second optical zone, so as to achieve suitable performance at the exit pupil of the eye optical system.

The MTF may be non-zero for objects having spatial frequencies of 0-100 line pairs per mm (lp/mm) at each location (i.e., for 20/20 vision). However, suitable performance can be achieved by maintaining a non-zero MTF for objects having spatial frequencies of 0-50 lp/mm (i.e., for 20/40 vision) at each location or spatial frequencies of 0-75 lp/mm (i.e., for 20/30 vision) at each location. A lens may be configured such that a near focal plane is located 1 meter or closer to the front of the eye (e.g., a wearer would have a suitable depth of field from infinity to a distance appropriate for typical human interaction (e.g. conversation)). Alternatively, a lens may be configured such that a near focal plane is located 65 centimeters or closer to the front of the (e.g., a wearer would have a suitable depth of field from infinity to a distance appropriate for reading).

The performance is typically achieved for polychromatic light of the photopic spectrum (approximately 400-700 nm) although other spectra may be used; appropriate performance at the central wavelength 555 nm is usually suitable for determining suitable performance across the entire spectrum. It will be appreciated that wavelengths of light above or below certain lengths are not perceivable by an average eye and are therefore insignificant.

The lens can be designed to perform for a maximum iris diameter of 2-6 mm (e.g., 2 mm, 3 mm, 4 mm, 5 mm or 6 mm). As one of ordinary skill in the art would understand, a lens providing suitable performance at 6 mm will have suitable performance if truncated for use with a smaller iris diameter.

Typically, a lens suitable for vision can be achieved when the optimization is performed for light in the photopic spectrum, and for an iris size of 6 mm. Typically, if performance is suitable at the middle of the spectrum (e.g., 550 nm), performance will be suitable across the spectrum. It will be appreciated that embodiments of lenses can be designed to perform with any suitable combination of bandwidths, iris sizes, spatial frequencies, near and far focus, and other lens performance parameters as deemed appropriate for a given wearer of the lens.

A first zone or second zone can be designed such that a portion of the zone (i.e., measured across a range of radii measured from the vertex of the lens) has single focal length thereacross. Accordingly, the zone can have a continuously varying focal length across the entire zone (with a peak in optical response defining the zone's focal length in the manner described above). An example of a lens having a zone with a continuously varying curvatures is given in U.S. application 61/012,867 filed Dec. 11, 2007 by Pinto et al., and title OPHTHALMIC LENSES PROVIDING AN EXTENDED DEPTH OF FIELD.

In embodiments where each zone has a single focal length across a portion, a blend region can be located between zones such that for objects located between infinity and a near focus, the eye optical system MTF has no phase reversals. It is typically advantageous that aberrations (e.g., quadratic phase errors) of a lens be selected to control image quality for a given eye optical system.

Lenses according to aspects of the present invention can have any suitable number of zones. For example, a lens can be bifocal or trifocal or more. Additionally a lens may have any suitable number of zones of a common focal length. In embodiments having three or more zones, the lens may be constructed such that the lens MTF has no phase reversals in a region between the foci (i.e., between the peaks in optical response) of only two of the zones (e.g., a far and medium distance zone); and between said range and a foci (i.e., the peak in optical response) of a third zone, phase reversals occur. Additionally, in some embodiments no phase reversals may occur between any of the foci (i.e., peaks in optical response). It will be appreciated that lenses according to aspects of the present invention comprise at least two refractive zones (i.e. the zones are not diffractive lens); as such the two zones are not a part of a Fresnel zone plate.

For example, optimization to achieve a lens according to aspects of the present invention may be performed using any known or yet to be developed optical optimization software (e.g., Zemax, Oslo or Code V). One example of a technique 5 for designing lenses according to aspects of the invention is shown in FIG. 1C. The technique described below has been found to be particularly suitable for use with Zemax.

In a first step 10, a first lens having a first focal length is designed to have suitable performance at a first distance (e.g., the far distance of the ultimate multizonal lens when located in an average eye, typically infinity) using conventional design techniques. For example, the lens may be designed to have a suitable power and selected third-order aberrations (e.g., RMS wavefront) using the lens curvatures and conic terms as variables. During step 10, to achieve suitable performance, the lens may be stopped down to the diameter of the center zone of the ultimate multizonal lens or not. As one of ordinary skill would understand the design is performed for a suitable iris aperture and spectral bandwidth. As is apparent from the discussion below, step 10 constitutes an example of a step of designing a first zone for vision at a first focal plane.

In a second step 20, a lens having a second focal length is designed to have suitable performance at a near distance (e.g., as stated above, the near distance of the ultimate multizonal lens when located in an average eye, for example, 65 centimeters) using conventional design techniques. For example, the lens may be designed to provide a suitable power and third-order aberrations (e.g., RMS wavefront) using the lens curvatures and conic terms as variables. During step 20, to achieve suitable performance, the lens may be designed with a central obstruction having a diameter equal to the diameter of the center zone of the ultimate multizonal lens or not. As one of ordinary skill would understand the design is performed for a suitable iris aperture and spectral bandwidth. As is apparent from the discussion below, step 20 constitutes an example of a step of designing a second zone for vision at a second focal plane.

In a third step 30, the lenses designed in the first and second steps are combined into a single optical system. However, an aperture is disposed so as to form an on-axis first zone comprising a portion of one of the first lens and the second lens. The size of the aperture is selected such that light is transmitted through only the portion of the lens that will be used in the ultimate multizonal lens (e.g., a circular zone having approximately a 1 mm radius). Similarly, a central obstruction is placed on the other of the lenses to form an annular zone. The size of the obstruction is selected such that light is transmitted through only the annular portion of the lens as will be used in the ultimate multizonal lens (e.g., an annular zone having an inner radial coordinate of 1 mm (i.e., measured from the vertex of the lens) and an outer radial coordinate of 5 mm). Finally, the lenses are positioned such that the vertices of the lenses are displaced from one another to form a continuous anterior surface including both an inner zone formed by the first lens and an outer zone formed by the second lens. The thickness of one or both of the lenses may be selected such that the posterior surface formed by the two lenses forms a continuous surface. It will be appreciated that the first zone has a first focal plane and the second zone has a second focal plane, when the lens is located in an eye (e.g., the average eye).

In a fourth step 40, the optical system including the first lens and the second lens, which are apertured and obstructed as set forth in the previous steps, are optimized with the second derivatives targeted to be zero at the exit pupil of the eye optical system over a selected depth of field of the eye as set forth above. As with the above steps, the lens is optimized while located in the average eye. During this optimization step, even aspheric terms are used as variable. The conic and radius of curvature terms of the surfaces and zones may be held constant to preserve the focal lengths that were achieved in steps 10 and 20. Alternatively, the conics and radii of curvature may be used as variables in addition to the aspheric terms, and the focal lengths of the lens zones monitored to maintain suitable performance. Lens thickness can be variable; however, an optical path difference (OPD) output and saggita (sag) output should be monitored to be sure that the lens output has continuous surfaces.

Table 2 illustrates one example of merit function constructed for Zemax that is suitable for producing lenses according to aspects of the present invention (e.g., use in step 4 above). The terms are specified for photopic light. It will be appreciated that, in the illustrated merit function, the second derivative target is provided only for a location intermediate the focus of the first zone and the focus of the second zone. Such a merit function provides greater calculation speed than if second derivative targets are provided for additional locations at or in between the focus of the first zone and the focus of the second zone. In such instances, it is assumed that the second derivatives at the first focus and the second focus will not deviate substantially from the values at the intermediate location.

TABLE 2

| | | | | | | |
|---|---|---|---|---|---|---|
| | Normalized | Normalized | Normalized | Normalized | | |
| type of | object position | object position | pupil position | pupil position | | |
| term | in x-dimension | in y-dimension | in x-dimension | in y-dimension | target | weight |

For a configuration in which an Object is 1000 mm away (i.e., an intermediate distance)

| | | | | | | |
|---|---|---|---|---|---|---|
| dxdx | 0 | 0 | 0 | 1 | 0.000 | −1.000 |
| dydy | 0 | 0 | 0 | 1 | 0.000 | −1.000 |
| dxdy | 0 | 0 | 0 | 1 | 0.000 | −1.000 |
| dydx | 0 | 0 | 0 | 1 | 0.000 | −1.000 |
| RMS | | | | | 0.000 | −1.000 |
| wavefront | | | | | | |
| error | | | | | | |

For a configuration in which an Object is 6000 mm away (i.e., an infinite distance)

| | | |
|---|---|---|
| RMS | 0.000 | −1.000 |
| wavefront | | |
| error | | |

For a configuration in which an Object is 650 mm away (i.e., a near distance)

| | | |
|---|---|---|
| RMS | 0.000 | −1.000 |
| wavefront | | |
| error | | |

The following are examples of embodiments of lenses configured such that, when the lens is applied to an average eye, for objects located between infinity and a near focal plane of the average eye, the MTF of the optical system has no phase reversals. Embodiments of lenses described herein were designed using Zemax version Jan. 22, 2007. Zemax design software is available from Zemax Development Corporation of Bellevue, Wash. All functional results described herein were calculated using computer simulation.

Although the example lenses are selected to have performance characteristics for objects in a certain range, the ranges are selected merely for illustration, and lenses according to aspects of the invention may have any suitable range.

### Example #1

Table 3 is a prescription for a first example of an embodiment of a lens according to aspects of the present invention. Table 3 illustrates an example of a single-element, intraocular lens (IOL) made of an example hydrophilic acrylic material having an index of refraction equal to approximately 1.46 for the d-wavelength of 0.589 micrometers; and as a function of wavelength (λ), n equals

$$1.38529196 + ( \frac{1.12901134 E - 02}{λ} ) + ( \frac{2.29091649 E - 04}{{λ}^{3.5}} ) ,$$

where wavelength is given in microns. A portion of each of the anterior zones, and a portion of the posterior surface have a single focal length thereacross. The lens has a center thickness of 1.00 mm.

TABLE 3

| | | Inner | Outer | Radius | | | | |
|---|---|---|---|---|---|---|---|---|
| | | Radial | Radial | Of | | | | |
| | | Boundary | Boundary | Curvature R | Conic | α₁ | | |
| Surface | Zone | (mm) | (mm) | (mm) | Constant k | (mm) | α₂ (mm) | α₃(mm) |
| Anterior | Inner | 0.0 | 1.2 | −1.082E+24 | 0 | 0 | −1.859E−04 | 6.908138E−003 |
| Anterior | Outer | 1.2 | 3.0 | 5.410543 | 0 | 0 | −0.027898 | 5.536347E−003 |
| Posterior | | 0 | 3.0 | −19.065136 | 0 | 0 | 0.020176 | 0 |

The lens described in Table 3 is a 20 diopter lens having two aspheric zones on the anterior surface and one aspheric zone on the posterior surface (i.e., the lens has two zones). The inner zone provides a 1.5 diopter add. The first surface includes only even-powered aspheric terms (and no conic term). The radial boundaries are measured form the lens vertex to a corresponding perimeter of the zone. To insert the IOL into the average eye model above, (1) the Anterior Surface, the Intermediate Surface and the Posterior Surface of the average eye are omitted; and (2) the Anterior surface of the IOL is positioned 1.5 mm behind the iris. As discussed above, for this and all subsequent examples, the retinal surface is positioned at best focus.

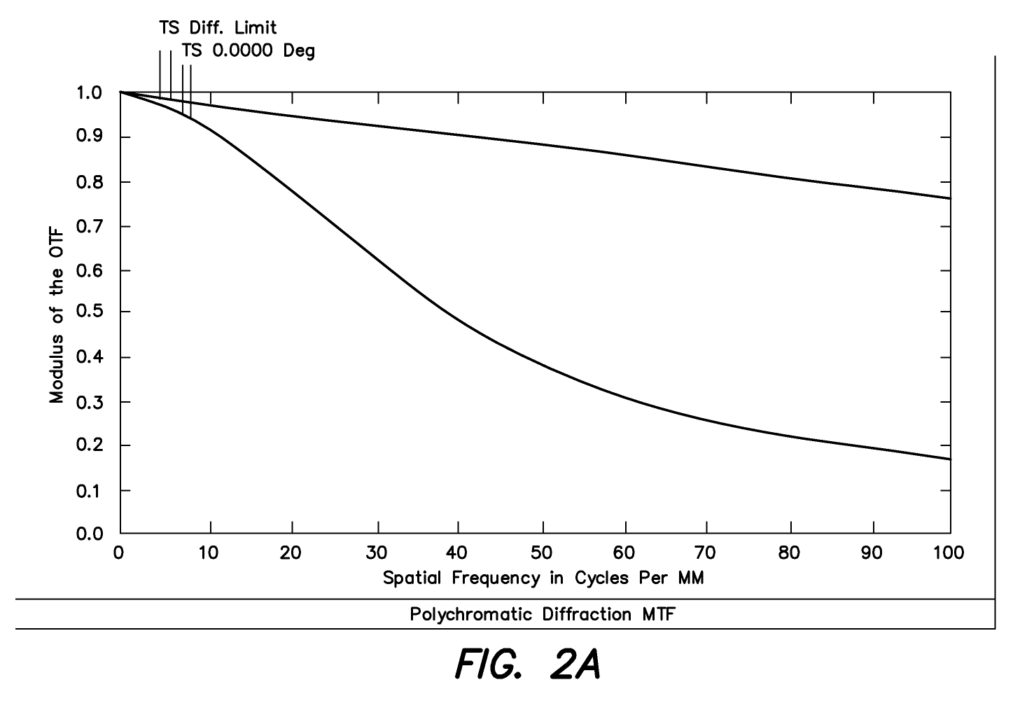

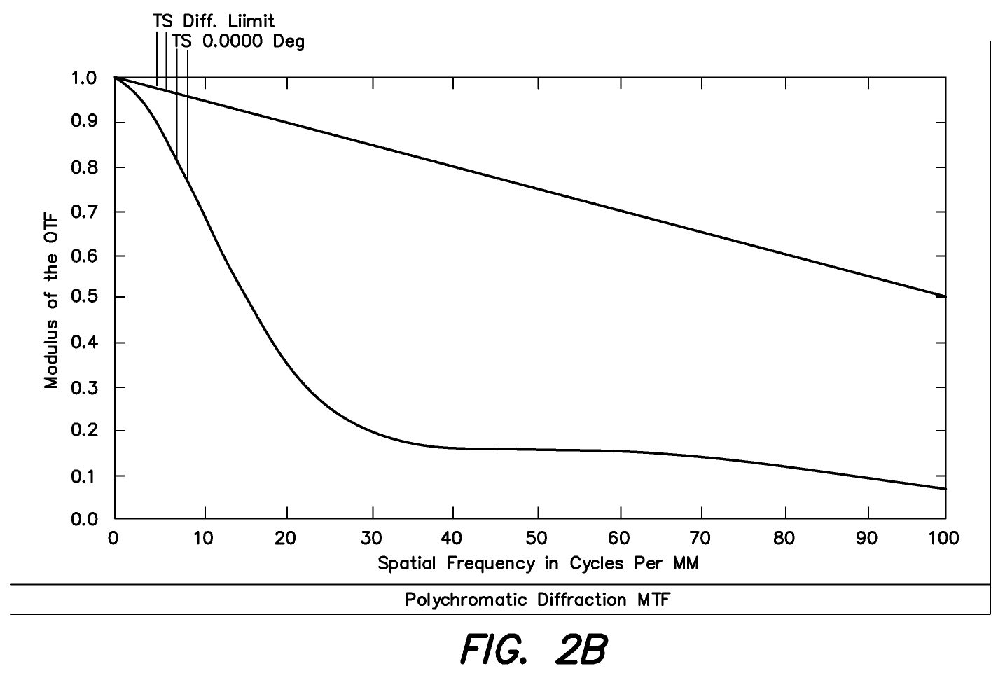

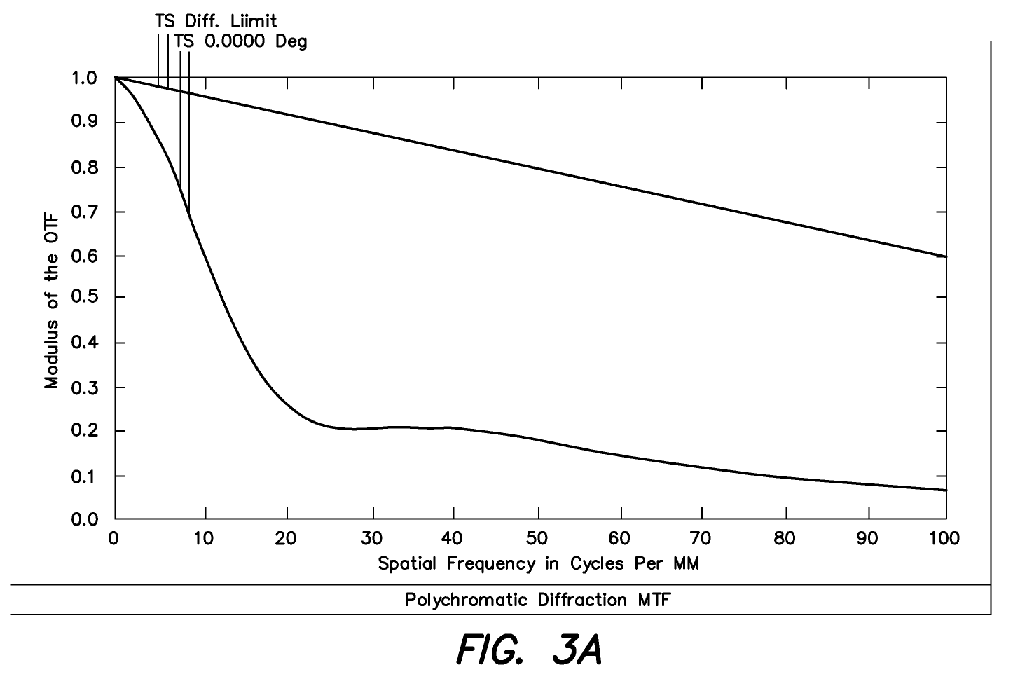

MTF plots at the retina (i.e., after the light passes through the eye optical system including the IOL) for an infinite object position, and a 1.0 diopter object position are shown in FIGS. 2A and 2B, respectively. The lens is an IOL applied to the average eye as set forth above in the Summary and the results are shown for a 6 mm diameter iris and a photopic spectrum of light. The lens provides no phase reversals out to a spatial frequency of 100 cycles/mm and beyond.

### Example 2

Table 4 is a prescription for a second example of an embodiment of a lens according to aspects of the present invention. Table 4 illustrates an example of a single-element, intraocular lens (IOL) made of an example hydrophilic acrylic material having an index of refraction as set forth above in Example 1. Each of inner and outer zones on the anterior surface, and the posterior surface has a continuously varying focal length across the entire zone (as described above).

TABLE 4

| | | Inner | Outer | Radius | | | | |
|---|---|---|---|---|---|---|---|---|
| | | Radial | Radial | Of | | | | |
| | | Boundary | Boundary | Curvature R | Conic | α₁ | | |
| Surface | Zone | (mm) | (mm) | (mm) | Constant k | (mm) | α₂ (mm) | α₃(mm) |
| Anterior | Inner | 0.0 | 1.4 | 13.680 | 0 | 0 | −5360098E−03 | 1.237122E−03 |
| Anterior | Outer | 1.4 | 3.0 | 27.341 | 0 | 0 | 4.118956E−03 | −3.89569E−04 |
| Posterior | | 0 | 3.0 | −10.6383 | 0 | 0 | 2.000E−03 | 0 |

The lens described in Table 4 is a 20 diopter lens having two aspheric zones on the anterior surface and one aspheric zone on the posterior surface. The inner zone provides a 1.5 diopter add. The first surface includes only even-powered aspheric terms (and no conic term). To insert the IOL into the average eye model above, (1) the Anterior Surface, the Intermediate Surface and the Posterior Surface of the average eye are omitted; and (2) the Anterior surface of the IOL is positioned 1.5 mm behind the iris.

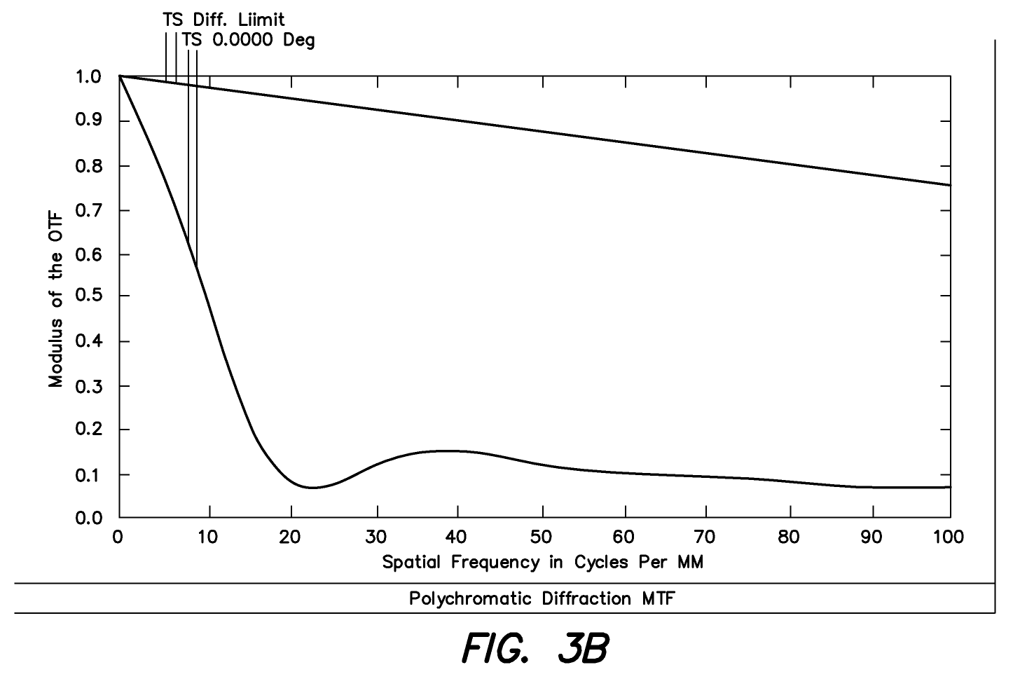

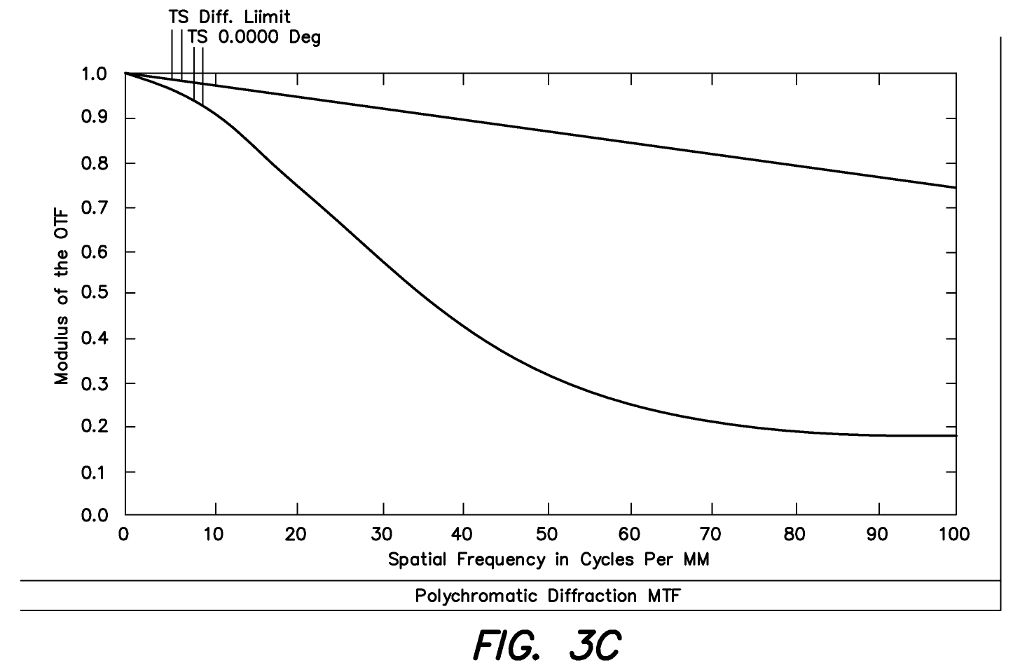

MTF plots at the retina (i.e., after the light passes through the eye ophthalmic system including the IOL) for an infinite object position, a 1.0 diopter object position and a 1.5 diopter position are shown in FIGS. 3A, 3B and 3C, respectively. The lens is an IOL applied to the average eye as set forth above in the Summary and the results are shown for a 6 mm diameter iris and a photopic spectrum of light. The lens provides no phase reversals out to a spatial frequency of 100 cycles/mm and beyond.

### Example 3

Table 5 is a prescription for a third example of an embodiment of a lens according to aspects of the present invention. Table 5 illustrates an example of a single-element, intraocular lens (IOL) made of an example hydrophilic acrylic material having an index of refraction as set forth above in Example 1. Each of inner and outer zones on both the anterior surface and the posterior surface has continuously varying focal length across the entire zone.

TABLE 5

| | | Inner | Outer | | | | | | |
|---|---|---|---|---|---|---|---|---|---|
| | | Radial | Radial | Radius | | | | | |
| | | Boundary | Boundary | of Curvature R | Conic | α₁ | α₂ | α₃ | α₄ |
| Surface | Zone | (mm) | (mm) | (mm) | Constant k | (mm) | (mm) | (mm) | (mm) |
| Anterior | Inner | 0 | 0.625 | 2.6532E−31 | −308.222 | 0.002 | −0.007 | 0.026 | −2.967E−02 |
| Anterior | Outer | 0.625 | 2.5 | −5.9197E17 | 5.231E18 | 0.053 | 0.009 | −5.300E−06 | 2.319E−06 |
| Posterior | Inner | 0 | 0.625 | 1.0805E−40 | −1281.765 | −0.026 | −0.009 | −0.034 | −2385E−01 |
| Posterior | Outer | 0.625 | 2.5 | 2.7835E284 | −3.746E261 | 3.8121 | −4.4691E−4 | −2.202E−05 | −3.953E−08 |

The lens described in Table 5 is a 20 diopter lens having two aspheric zones on the anterior surface and one aspheric zone on the posterior surface. The inner zone provides a 1.5 diopter add. The first surface includes only even-powered aspheric terms (and conic terms). To insert the IOL into the average eye model above, (1) the Anterior Surface, the Intermediate Surface and the Posterior Surface of the average eye are omitted; and (2) the anterior surface of the IOL is positioned 1.5 mm behind the iris.

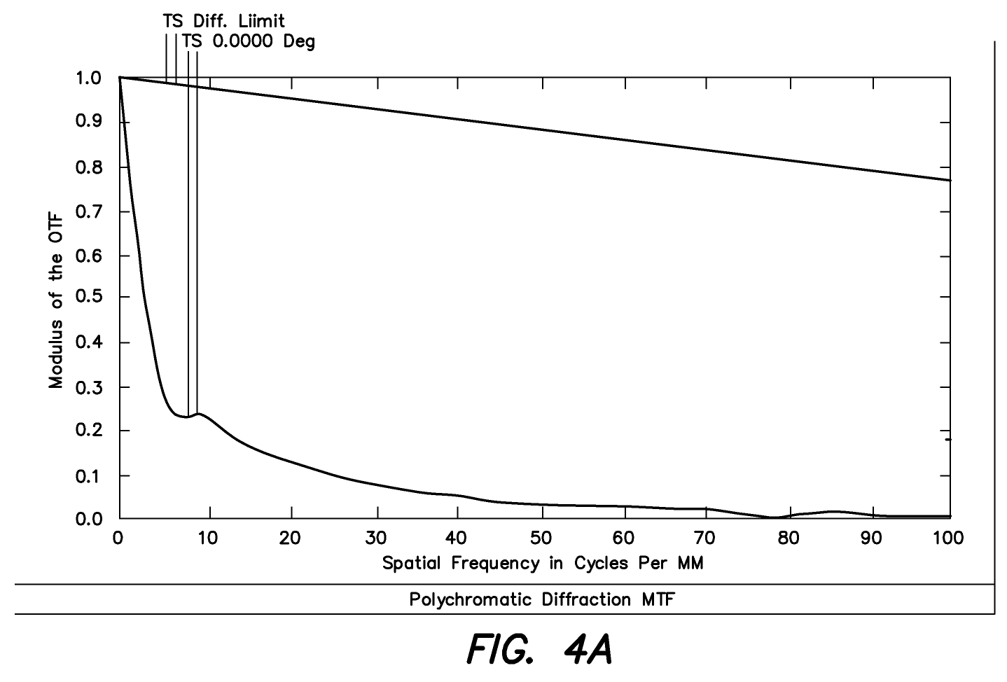

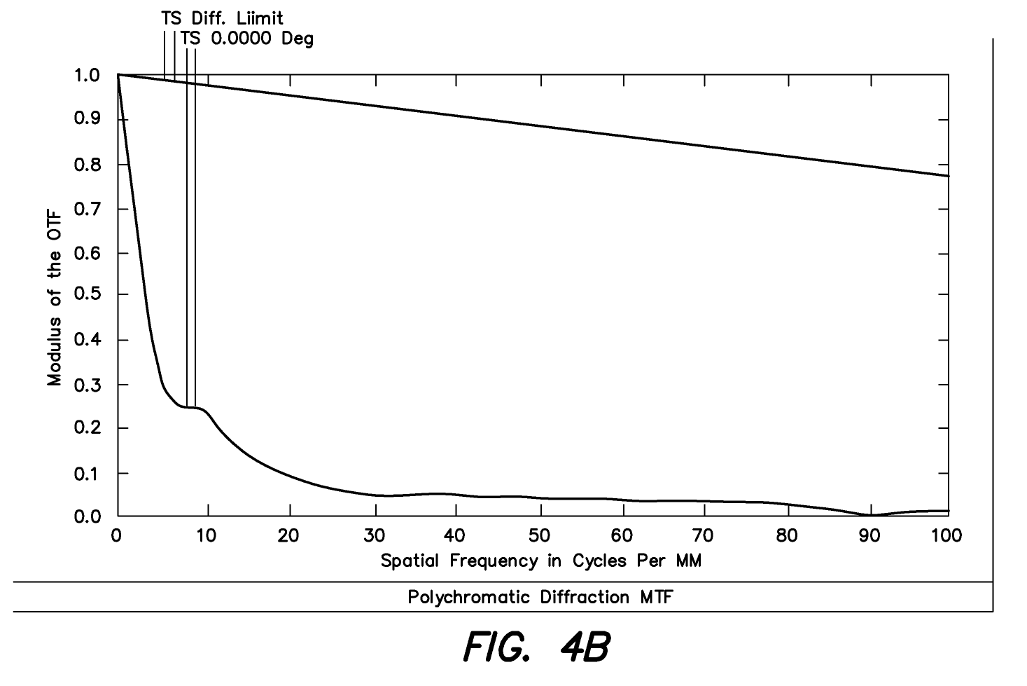

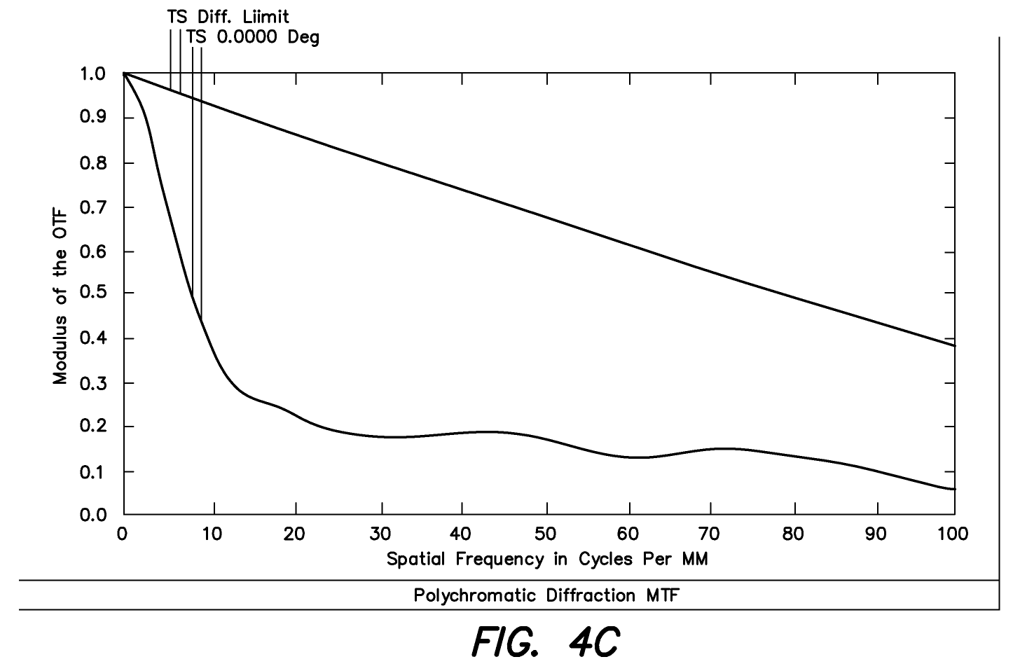

MTF plots at the retina (i.e., after the light passes through the eye optical system) for an infinite object position, a 1.0 diopter object position and a 1.5 diopter position are shown in FIGS. 4A, 4B and 4C, respectively. The lens is an IOL applied to the average eye as set forth above in the Summary and the results are shown for a 6 mm diameter iris and a photopic spectrum of light. The lens provides no phase reversals out to a spatial frequency of about 78 cycles/mm, the phase reversal occurring for an object position at infinity.

### Example 4

Table 4 is a prescription for an example of a lens according to prior art techniques, the lens being similar to the lens of Example 3 without an optimization according to aspects of the present invention. Table 6 illustrates an example of a single-element, intraocular lens (IOL) made of an example hydrophilic acrylic material having an index of refraction as set forth above in Example 1.

TABLE 6

| | | Inner | Outer | Radius | | | | | |
|---|---|---|---|---|---|---|---|---|---|
| | | Radial | Radial | of | | | | | |
| | | Boundary | Boundary | Curvature R | Conic | α₁ | α₂ | α₃ | α₄ |
| Surface | Zone | (mm) | (mm) | (mm) | Constant k | (mm) | (mm) | (mm) | (mm) |
| Anterior | Inner | 0 | 0.625 | 12.5 | −413.662 | 0 | 0 | 0.026 | 0 |
| Anterior | Outer | 0.625 | 2.5 | 14.269571 | −1.064 | 0 | 0 | −5.300E−06 | 2.319E−06 |
| Posterior | Inner | 0 | 0.625 | −14.269571 | −19.468 | 0 | 0 | −0.034 | 0 |
| Posterior | Outer | 0.625 | 2.5 | −0.0701 | −1.719 | 0 | 0 | −2.202E−05 | −3.953E−08 |

The lens described in Table 6 is a 20 diopter lens having two aspheric zones on the anterior surface and one aspheric zone on the posterior surface. The inner zone provides a 1.5 diopter add. The first surface includes only even-powered aspheric terms (and conic terms).

To insert the IOL into the average-eye model above, (1) the Anterior Surface, the Intermediate Surface and the Posterior Surface of the average eye are omitted; and (2) the anterior surface of the IOL is positioned 1.5 mm behind the iris.

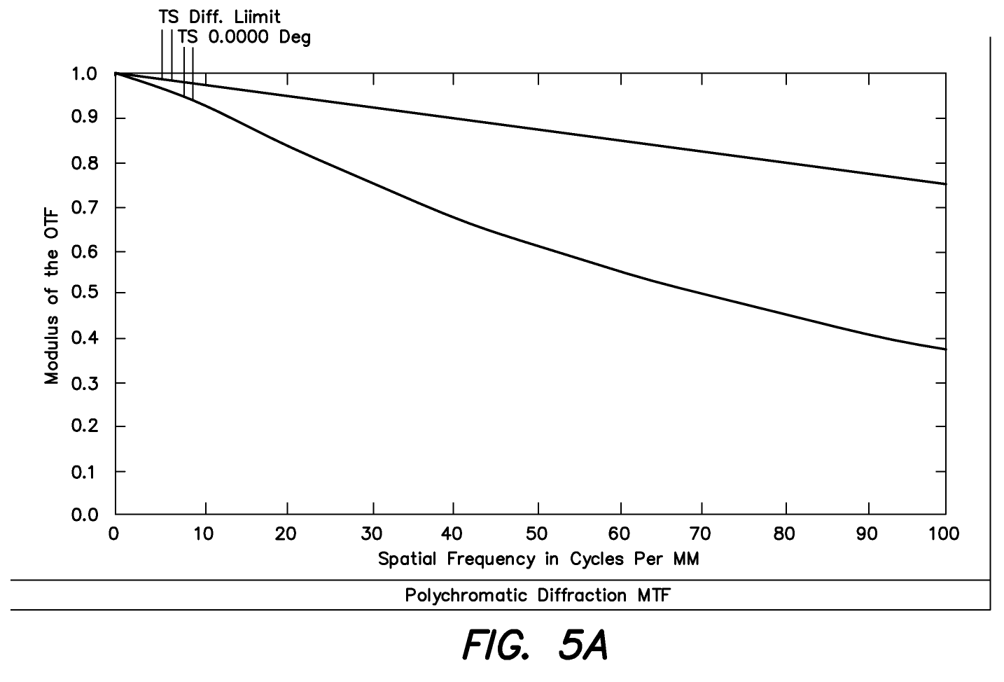

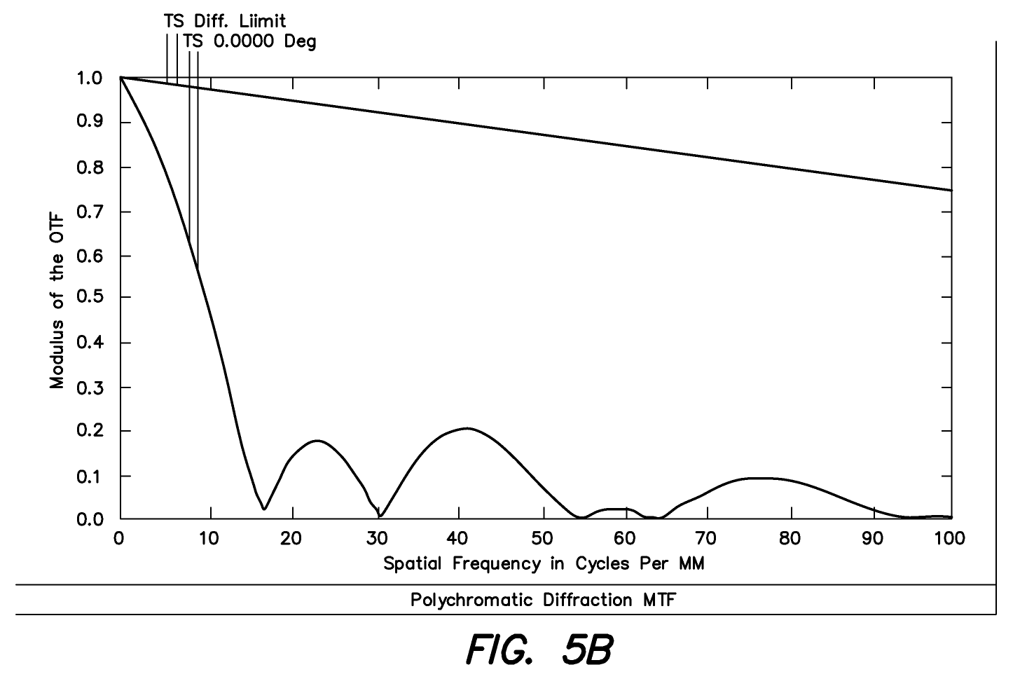

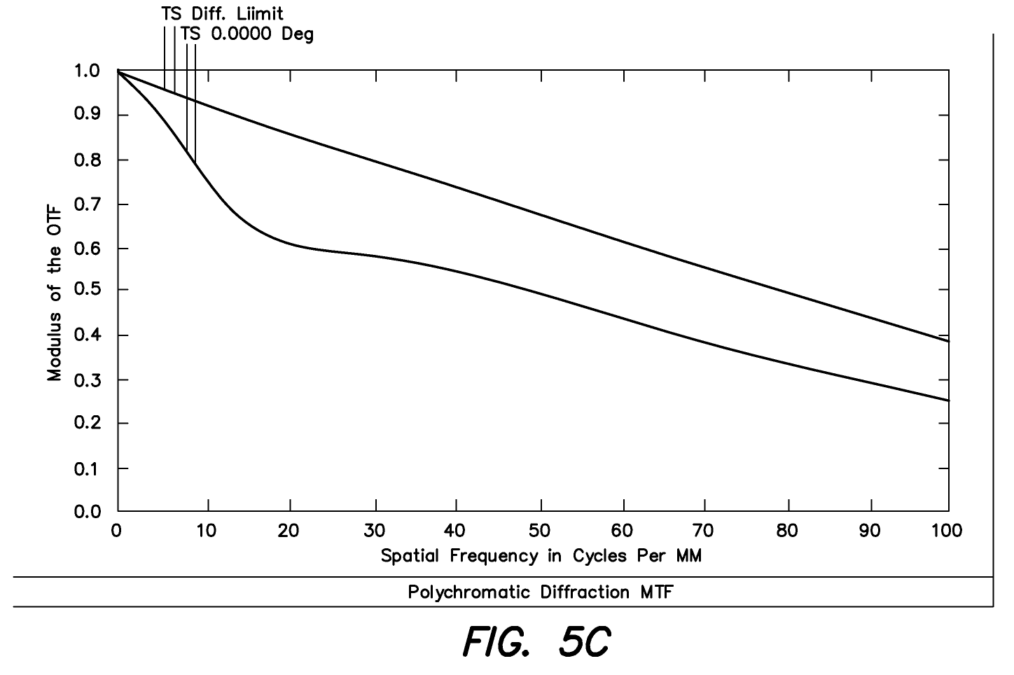

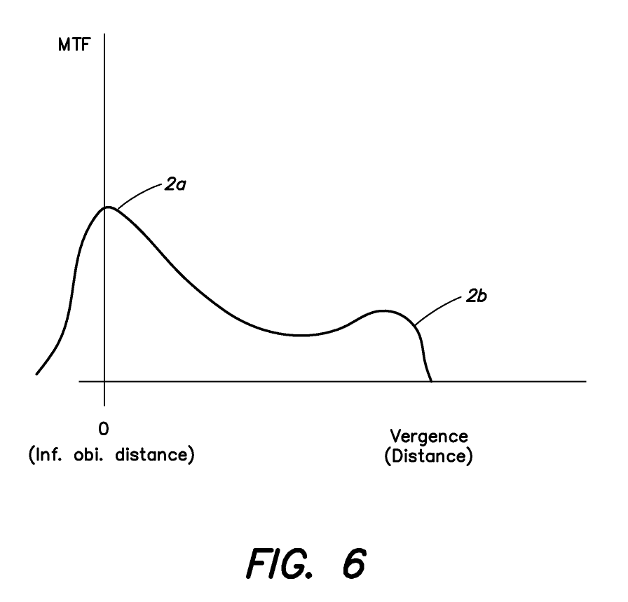

MTF plots at the retina (i.e., after the light passes through the eye optical system) for an infinite object position, a 1.0 diopter object position and a 1.5 diopter position are shown in FIGS. 5A, 5B and 5C, respectively. The lens is an IOL applied to the average eye as set forth above in the Summary and the results are shown for a 6 mm diameter iris and a photopic spectrum of light. It will be appreciated that the lens has multiple zero-crossings indicating the presence of phase reversals (and ghosting) in the plot of FIG. 5B. While the lens performs adequately at a near peak in response (i.e., at the near focus of the lens) and a far peak in response (i.e., at the far focus of the lens), at a location intermediate the peaks, the performance is inadequate. Such performance is to be contrasted with the MTF plots for example embodiments of the invention illustrated in FIGS. 2B, 3B and 4B.

Although the illustrated embodiments have only two zones, as stated above, lenses according to aspects of the present invention can have any suitable number of zones. For example, the lens can be bifocal or trifocal and have any suitable number of zones of a common focal length. In embodiments having three or more zones, the lens may be constructed such that, for objects located between infinity and one meter, the lens MTF has no phase reversals. Accordingly, comfortable vision can be achieved for infinity up to a typical distance for human interaction. In some embodiments, the lens is constructed such that, for objects located between infinity and 1 meter, the lens MTF has no phase reversals. Accordingly, comfortable vision can be achieved for infinity up to a typical distance for conversation. In some embodiments, the lens is constructed for vision from infinity up to a 65 mm, a typical distance for reading.

It is further to be appreciated that although even-powered polynomial terms may be all that is necessary to achieve selected aberration performance for a zone of a surface of a lens. For some embodiments, odd-powered polynomial terms may be added to a zone of a surface. For example, odd-powered aspheric terms may be appropriately used with contact lens embodiments, where decentration is likely. Additionally, a conic term may or may not be non-zero for a zone of a surface.

An optic may be used in an accommodative lens. For example, a lens according to aspects of the present invention can be used in a dual-element accommodative lens as described in U.S. Pat. No. 6,488,708 issued Dec. 4, 2002, to Sarfarazi, or a single element accommodative lens as described in U.S. Pat. No. 5,674,282, issued Sep. 7, 1997, to Cumming.

Use of a lens as described above may be achieved using any suitable application technique. For example, a contact lens will be applied to a wearer's eye by placing the lens on the wearer's cornea; and an IOL will be applied to a wearer's eye by inserting the lens into a wearer's eye (e.g., into the wearer's eye in the posterior chamber or anterior chamber).

Furthermore, selection of the power of a lens to be applied to a wearer's eye may be achieved using any suitable technique. According to one conventional technique, the power of the lens is selected to place the wearer's maximum contrast at infinity when the wearer's eye muscles are relaxed. Although the examples above are 20 diopter lenses, lenses of an suitable diopter power be provided; as stated above, to design a lens or determine performance of a lens of a given dioptric power, the retina in an eye model can be appropriately positioned.

Having thus described the inventive concepts and a number of exemplary embodiments, it will be apparent to those skilled in the art that the invention may be implemented in various ways, and that modifications and improvements will readily occur to such persons. Thus, the embodiments are not intended to be limiting and presented by way of example only. The invention is limited only as required by the following claims and equivalents thereto.

What is claimed is:

1. An ophthalmic lens, comprising:
at least one optic including a first zone and a second zone having a second zone,
the lens configured such that, when the lens is applied to an average eye, for objects located between infinity and a near focal plane of the average eye, an MTF of the eye's optical system has no phase reversals.

2. The lens of claim 1, wherein the lens is an intraocular lens.

3. The lens of claim 1, wherein the lens comprises an anterior surface and a posterior surface, and each of the anterior surface and the posterior surface have at least two zones.

4. The lens of claim 1, wherein the zones are concentric.

5. The lens of claim 1, wherein the lens has no phase reversal for objects having a spatial frequencies in a range 0-50 lp/mm.

6. The lens of claim 5, wherein the lens has no phase reversal for objects having a spatial frequencies in a range 0-75 lp/mm.

7. The lens of claim 6, wherein the lens has no phase reversal for objects having a spatial frequencies in a range 0-100 lp/mm.

8. The lens of claim 1, wherein the near focal plane is located 1 meter or closer to the front of the average eye.

9. The lens of claim 8, wherein a far focal plane of the lens is adapted to provide the average eye with vision at an infinite distance from the eye.

10. The lens of claim 1, wherein the near focal plane is located 65 centimeters or closer to the front of the eye.

11. The lens of claim 10, wherein a far focal plane of the lens is adapted to provide the average eye with vision at an infinite distance from the eye.

12. The lens of claim 1, where in the lens comprises a third zone.

13. The lens of claim 12, wherein each of the three zones has a different focal length.

14. The lens of claim 13, wherein the MTF has no phase reversals in a range between a focus of the first zone and a focus of the second zone.

15. The lens of claim 14, where the MTF has a phase reversal between a focus of the third zone and the range.

16. The lens of claim 15, wherein the lens is a single element lens.

17. A method of designing a multizonal lens using a model eye including the lens, comprising:
optimizing the lens such that second derivatives of a wavefront at an exit pupil of the model eye optical system are substantially zero.

18. The method of claim 17, wherein lens comprises a first zone having a first focal length and a second zone having a second wavelength.

19. The method of claim 18 wherein, when the lens is applied to an average eye, the first focal length provides a first focal plane located 1 meter or closer to the front of an the eye and the second focal length provides a second focal plane at infinity.

20. The method of claim 17, wherein the step of optimizing comprises using even aspheric terms of at least one of an anterior surface and a posterior surface of the lens as variables.

21. The method of claim 17, further comprising a step of designing a first zone for vision at a near focal plane, and a step of designing a second zone for vision at a far focal plane, both step being performed prior to the step of optimizing the lens.
